(19) United States
(12) Patent Application Publication
(10) Pub. No.: US 2010/0132303 A1
(43) Pub. Date: Jun. 3, 2010

(54) STRUCTURAL PANELS AND METHODS OF MAKING THEM

(76) Inventor: Kevin Patrick Gill, Lincoln, NE (US)

Correspondence Address: VINCENT L. CARNEY LAW OFFICE, P.O. BOX 80836, LINCOLN, NE, 68501-0836, US

(21) Appl. No.: 12/327,075

(22) Filed: Dec. 3, 2008

(51) Int. Cl. E04B 1/00; B32B 3/10; B32B 37/12

(52) U.S. Cl. 52/745.13; 428/203; 428/172; 156/60; 156/280

(57) ABSTRACT

A structural panel includes an impermeable solid base sheet that has one side adapted to adhere to a surface such as by mortar or grouting and having a second side adapted to receive decorative material. For example, the second side may include pieces forming a mosaic or may include artwork in relief or colors and the like. The panel is sealed with a smooth outer surface that may be transparent or translucent or may be partly transparent but colored. This material is the equivalent of self-leveling materials such as those that form a smooth level surface such as a liquid or semi-solid and then harden while maintaining the smooth surface.

### BACKGROUND OF THE INVENTION

This invention relates to structural panels such as may be used as flooring or wall covering or counter covering and to methods of making and using the panels. Structural panels are known in the prior art.

It is known to fasten decorative materials on a mesh. The prior art decorative panels formed by gluing artistic materials or pieces of artistic material on a mesh are not preformed with a clear protective coat but are sold to the users glued to the mesh.

It is known to apply clear protective coats to structural members or to structures such as on masonry floors or walls and it is known to use such coats on decorative materials such as photographs that are not structural members.

There is a need for panels which are strong and resist damage and still are decorative and can be fastened to walls, floors, counters or the like.

One disadvantage of the prior art meshes is that glue or base materials applied to it will ooze through the mesh and cause some difficulty in preparing the panels. In the prior art techniques, a cement mixture or grout or glue is laid on top of the mesh and decorative pieces are glued in place and left to harden. After the pieces have hardened, grouting is placed between the pieces and a sealant is put on top of the overall piece. To fill in the spaces between the pieces, grouting material is placed on top of the glued down pieces and the material over the tile is removed such as by wiping, such as for example with water or any other material that will not damage the surface of the decorative material but will aid in removing the grouting on the decorative material and leaving it between the pieces of decorative material. Then the sealant is placed over the overall panel. The sealant is intended to protect the grout between the pieces from too freely cracking and dropping free. It may also serve the purpose of giving a shiny or polished appearance to the overall structural member and thus enhance its decorative affect.

The prior art of sealants lack sufficient strength against abrasion or damage under high use. The prior art of sealants is thin and does not leave a perfectly level surface but instead, depressions remain at the location of the grout between the pieces of the mosaic. It is also known to have decorative colors and decorative vertical objects. In the prior art, these are generally made by carving the outside of existing solid vertical members. This has the disadvantage of requiring expensive hand work and being limited in the decorative affects that are possible.

### SUMMARY OF THE INVENTION

Accordingly it is an object of the invention to provide a novel structural panel.

It is a further object of the invention to provide a novel method of making structural panels.

It is a still further object of the invention to have a novel method for making either vertical or horizontally laid structural panels.

It is a still further object of the invention to provide a structural panel which provides special visual affects.

It is a further object of the invention to provide a structural panel which may display three dimensional images and yet have a smooth sturdy external surface that resists marring.

It is a still further object to provide a structural member containing works of art of almost any type which will have a strong protective outer surface.

It is a still further object of the invention to provide a method of marketing that reduces the cost of installing paneling.

In accordance with the above and further objects of the invention, a structural panel is provided that is particularly useful for decorating surfaces that may be subject to considerable wear and tear such as flooring and walls and the like. The structural panel includes a impermeable solid base sheet that has one side adapted to adhere to a surface such as by mortar or grouting and having a second side adapted to receive decorative material. For example, the second side may include pieces forming a mosaic or may include artwork in relief or colors and the like. The panel is sealed with a smooth outer surface that may be transparent or translucent or may be partly transparent but colored. This material is the equivalent of self-leveling materials such as those that form a smooth level surface as a liquid or semi-solid and then harden while maintaining the smooth surface. In this specification, the words, “impermeable sheet” means a base sheet having a bottom surface and a top surface that is constructed to separate glue, grouting, adhesive, binder, putty or other substance used to cause material to adhere to the top surface from the bottom surface. The bottom surface is intended to rest on a support while the glue, grouting, adhesive, binder, putty or other substance is used to bind an object or objects to the top surface so that the impermeable sheet will not stick to the support. In this specification, the words “solid base sheet” means a member or plurality of members that support the structural panel while it is being constructed. It may remain as part of the structural panel and be embedded in a structure such as flooring or attached to a wall.

In the preferred embodiment, the impermeable sheet is a solid sheet having an uneven surface and a seal includes at least one functional sized and shaped seal. With this arrangement, the impermeable sheet has a series of ridges that permit some movement of decorative items glued to the top surface and thus avoids some cracking that otherwise would occur. The seal provides a smooth abrasion resistant top surface which is even and easily cleaned even though the decorative members and the grouting between the members on the impermeable sheet may be uneven.

The decorative members may be a mosaic consisting of multiple, decorative, separate pieces each of which is fastened to the solid base sheet or may instead be a single or a number of artistic works such as paintings or sketches or designs or the like. The decorative member may also be an etching or a design in relief with the seal providing the smooth upper surface for the relief or three dimensional artwork. The seal in the preferred embodiment is either a time hardenable transformable material or a chemically hardenable transformable material and preferably is an epoxy. In this specification, the words “transformable material” means a material that changes phase or state with time or by chemical reaction such as from a liquid or semisolid material to a solid material.

In this specification, three types of transformatble materials are specifically mentioned although other types may be covered. The three types that are specifically mentioned are time transformable material, chemically transformable material and hardenable transformable material. In this specification the words “time transformable material” means transformable material that changes from one phase or state to another with time. The words “chemically transformable material” means transformable material that changes from one phase or state to another with chemical reaction such as a reaction with another material. An epoxy is one such material. The words “hardenable transformable material” means material that becomes solid from a more mobile state such as a liquid, such as a time hardenable transformable material being a material that hardens with time into a solid.

To make a structural panel, a solid base sheet is placed on a support surface and at least one decorative member is connected or fastened to the solid base sheet, such as for example by glue, cement, grout compound or the like. After the decorative members have been fastened in place, a functional sized and shaped seal is applied. Preferably, the solid base sheet is an impermeable sheet. However, the process may start with a permeable base sheet that has the openings closed with a removable material prior to applying a decorative member. When the adhesive material is applied, the openings in the permeable based sheet are closed with the removable material and after the adhesive is dried to hold the decorative members in place, the removable material is removed. Preferably, the functional sized and shaped seal is a light passing epoxy so that at least one of the decorative members may be seen through the epoxy.

The structural panels are installed after a plurality of the panels have been formed. The formed individual panels are delivered to a purchaser and installed by the purchaser. To install panels on flooring or on a countertop, the purchaser generally applies a base material which in itself is adhesive or applies adhesive and lays down the preformed panels on the adhesive. Preferably, the purchaser will put down mortar and press the structural members against the mortar on the surface that is to receive the panels. To install panels on a wall, the panels may be hung by brackets.

As can be understood from the above description, the structural member of this invention has several advantages, such as: (1) it has a smooth abrasion resistant surface even though it contains decorative members which may be spaced from each other or have irregular top surfaces; (2) it is relatively easy to fabricate; and (3) it is relatively easy and inexpensive to install.

The method of making the structural panels also has several advantages such as for example the adhesive material does not seep through the base material because the base is solid and generally impermeable and it is relatively simple to handle. The installation is relatively simple because substantially completely formed members are sold to purchasers who may install them themselves or hire a contractor of their own choice to install them on site.

### SUMMARY OF THE DRAWINGS

The above noted and other objects of the invention will be better understood with reference to the accompanying drawings, in which:

FIG. 1 is a elevational view, partly sectioned, of an installed panel in accordance with an embodiment of the invention;

FIG. 2 is a flow diagram of a method of installing a structural panel in accordance with an embodiment of the invention;

FIG. 3 is a flow diagram of the step of applying functional sized and shaped seals of the process of FIG. 2;

FIG. 4 is a flow diagram of a process for handling the marketing of structural panels;

FIG. 5 is a perspective view illustrating the manner in which a section of solid base sheet is cut from a larger roll;

FIG. 6 is a plan view of a preferred embodiment of impermeable sheet used as a base sheet;

FIG. 7 is a plan view illustrating the spreading of an adhesive material on the impermeable sheet of FIG. 6;

FIG. 8 is a plan view showing one type of mosaic structural member with the pieces adhered to a base sheet;

FIG. 9 is a plan view of another design;

FIG. 10 is a schematic pictorial view showing one manner of applying grout;

FIG. 11 is a schematic pictorial view showing excess grout being removed;

FIG. 12 is a simplified perspective view showing one manner in which a functional sized and shaped seal may be applied such as by pouring on epoxy;

FIG. 13 is a simplified perspective view illustrating one manner in which a seal may be applied;

FIG. 14 is a simplified perspective view showing another manner in which a seal may be applied to the structural panel; and

FIGS. 15 and 16 show one pictorial and one mosaic completed structural panels.

### DETAILED DESCRIPTION

In FIG. 1, there is shown an elevational view of partly sectioned of the combination of a structural member and flooring to which it is mounted having a structural panel 14 and concrete flooring 12. The structural panel 14 is mounted to the flooring 12 by putty or other adhesive or glue 16. It includes an impermeable base sheet 18, an adhesive layer 20, a decorative layer 22, a functional sized and shaped seal 36, and an upper seal 38. The putty or other adhesive 16 mounts the impermeable base sheet 18 to the flooring 12 or to a wall or other member. Another layer of adhesive 20 mounts a design material such as the mosaic elements 24, 26 and 28 which may have different thicknesses or the same thicknesses. Between the individual elements 22, 24, 26 and 28, there is grouting to fill in the space such as shown at 30, 32 and 34. Above all of these, the functional sized and shaped seal 36 extends to form a casing of hard material with a self-leveling surface. This layer extends around the top of the structural elements 22, 24, 26 and 28 to resist abrasion and yet permit visibility to the design. Optionally, on top of the functional sized and shaped seal 36 is a thinner strong abrasion resistant seal 38 which also permits viewing of the decorative design beneath the functional sized and shaped seal 36.

Of course, the panels may be installed in other manners such as by being hung by brackets or by being installed on a countertop. With this arrangement, a sturdy structural panel 14 is formed having good abrasion resistance, ability to move slightly to avoid cracking and a decorative design. It is economical and easy to construct and may be easily laid on flooring or walling or any other surface for which decorative panels are appropriate. It has a smooth outer surface and is easy to clean and maintains its appearance over a long period of time.

In FIG. 2, there is shown a process 40 having the step 42 of obtaining an impermeable base sheet, the step 44 of applying decorative members to the base sheet and the step 46 of applying a functional sized and shaped seal to the impermeable base sheet and decorative member or members. The impermeable base sheet may be purchased as an impermeable polyurethane sheet having ridges and square shaped depressions to permit moveability. A suitable such material is sold under the trademark Schulter-DITA Universal Underlayment and is sold for mounting tile and stone. It is available from Schulter Systems L.P., 194 Pleasant Ridge Road, Plattsburgh, N.Y. 12901-5841 and distributors at other locations in the United States as well as in other countries.

In the alternative, a permeable fabric material or fleece may be supported by wax or other member to close the pores and used as an impermeable base sheet to apply adhesive and decorative material.

The adhesive material for attaching decorative ceramic materials to the impermeable base sheet may be any commercial ceramic tile adhesive. Colored tiles to form a mosaic may be adhered to the base sheet or colored dust or air painted designs or any other decoration may be applied and the adhesive permitted to dry. Other types of substances may be used as well, such as glitter, stones, minerals, tree leaves and the like or any combination of these. The space between the design elements 22, 24, 26 and 28 (FIG. 1) may be grouted to form a solid surface but the surface need not be smooth. Even biodegradeable material such as leaves may be used and still the structural panel will be long lived.

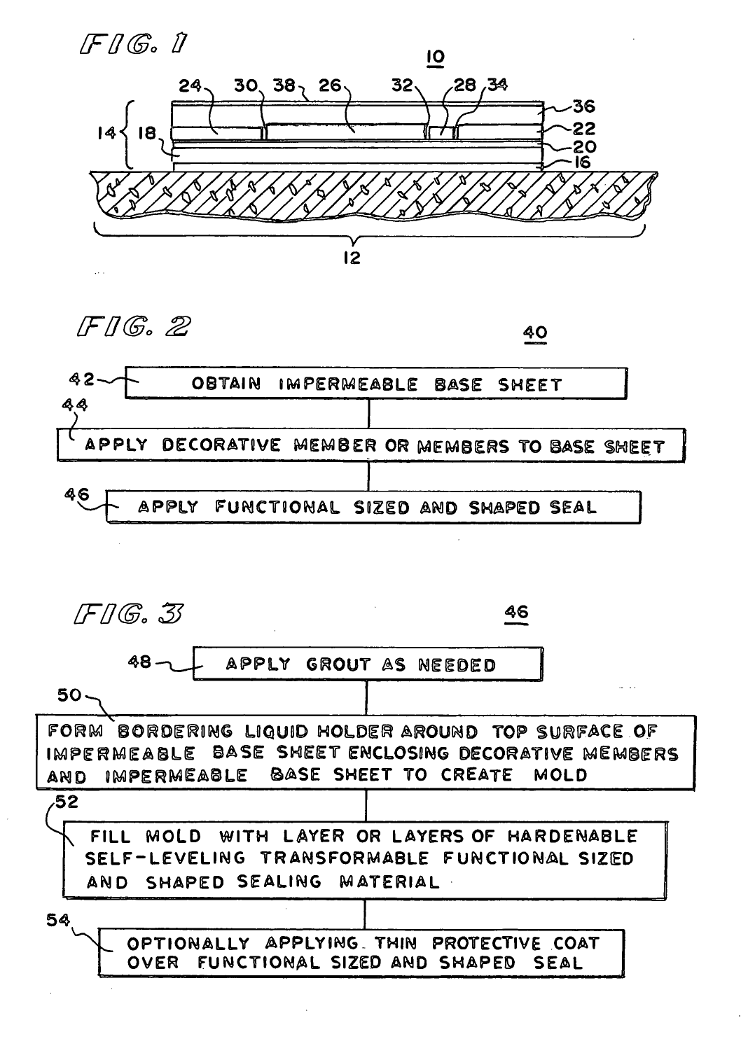

In FIG. 3, there is shown a flow diagram of the step 46 of FIG. 2 of applying a functional sized and shaped seal including the substep 48 of applying grout as needed, the substep 50 of forming a bordering liquid holder around the top surface of the impermeable base sheet enclosing attached decorative members and the base sheet to create a mold, the substep 52 of filling the mold with layer or layers of hardenable self-leveling transformable functional sized and shaped sealing material. The substep 52 of applying a hardenable transformable functional sized and shaped sealing material may be followed by the substep 54 of applying a further thin protective coat on the level surface of the functional sized and shaped seal after the hardenable transformable functional sized and shaped sealing material has hardened. In the preferred embodiment, the transformable material is a chemical transformable material but could be time transformable or heat transformable. In the preferred embodiment, the transformable material is a clear epoxy but could be a tinted transformable material. An epoxy manufactured and sold by PPG under the trademark Aqua Pon may be used. This epoxy is abrasion and chemically resistant. The full protected coat may be that disclosed in U.S. Pat. No. 5,618,860.

In FIG. 4, there is shown a flow diagram 56 of a process for marketing structural panels including the substep 58 of forming a plurality of structural panels, the substep 60 of delivering the plurality of structural panels to at least one purchaser and the substep 62 of applying the structural panels to the purchasers structure, or if the purchaser is a contractor or distributor, to the structure of the contractor's or distributor's customer.

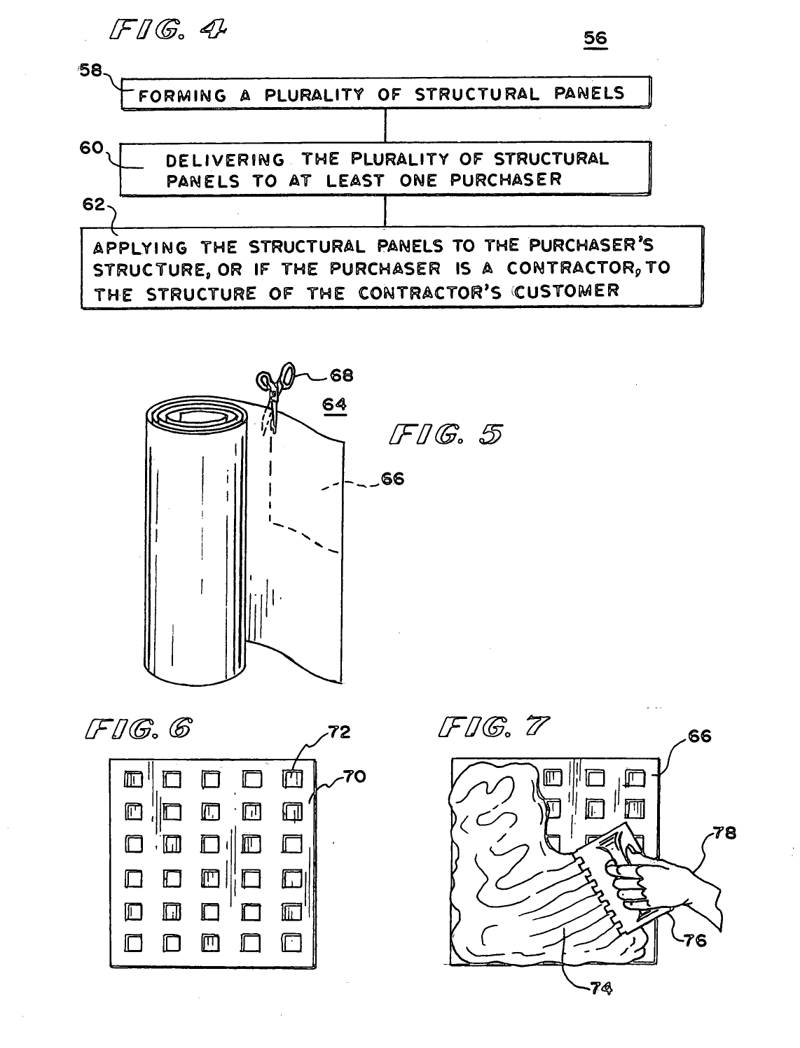

In FIGS. 5-14, there is shown a progression of steps for forming a structured panel in accordance with the invention. FIGS. 15 and 16 show completed structural panels. The progression of steps starts with the step shown in FIG. 5 which illustrates a roll of impermeable sheet material 64 having a section 66 about to be cut by any implement shown diagrammatically as scissors 68. This material can be cut to size to form the base sheet for structural panels.

A section, such as the section 66 illustrated in FIG. 6, cut from the sheet material 64 (FIG. 5), may be any suitable size and shape. In the preferred embodiment, the section is a polyethelene sheet 70 with ridges and depressions 72 to provide lateral flexibility with respect to anything that is resting upon it.

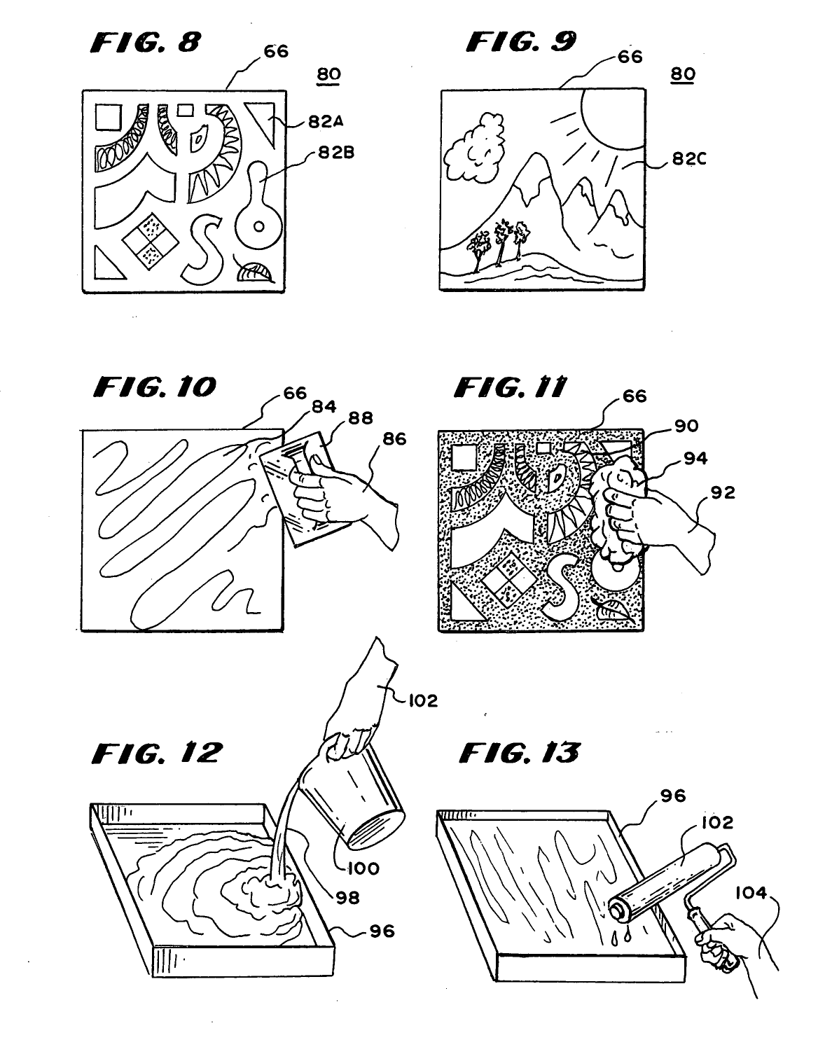

The next step in the progression is the step of spreading an adhesive material 74 over the top of the sheet 66 as shown in FIG. 7 by the person 78 moving an applicator 76. Once adhesive 74 is spread over the sheet 66, decorative items such as those shown at 82A and 82B, illustrated as substep 80 in FIG. 8, may be adhered to the sheet 66. As shown in FIG. 9, instead of decorative pieces such as 82A and 82B (FIG. 8), a painting 82C as a single decorative item may be painted on the base sheet or air brushed or a painting or photograph may be glued to the sheet 66. As still another alternative illustrated in FIG. 10, grout 84 may be spread by an applicator 88 being operated by a person 86. As illustrated in FIG. 11, excess grout may be removed such as by a sponge 94 as shown used by a person 92.

The next series of steps in this progression relates to the formation of a functional sized and shaped seal. In this specification the words “functional sized and shaped seal” means a sealing layer that is sized, shaped and of a material to provide a smooth surface above a structural panel and used to seal at least one or more ornamental objects. To form the functional sized and shaped seal, a border 96 is formed around the top surface of the impenetrable sheet with the decorative items on it. A hardenable self-leveling functional sized and shaped sealing material 98 is poured into the mold formed by the border walls 96 and the impervious base sheet with decorative items on it. This is indicated by the container 100 being poured by a person 102 into the mold formed by the border walls 96.

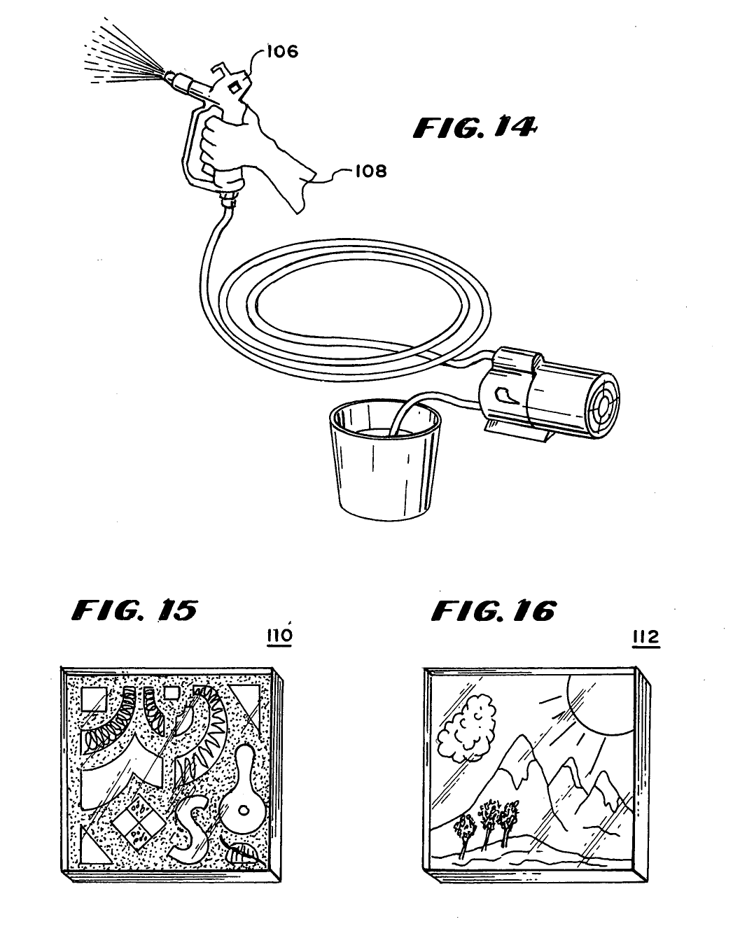

After the hardenable material has hardened, an additional protective layer may be placed on top of it such as by a roller 102 operated by a person 104 as shown in FIG. 13 or it may be sprayed such as shown in FIG. 14 from a spraying implement 106 operated by a person 108. This may result in display panels such as 110 with a strong protective outer surface and an underlying design as shown in FIG. 15, or as shown at 112 in FIG. 16 with a work of art. Moreover, transition strips may be placed around the border or picture frame.

Although a preferred embodiment of the invention has been described with some particularity, many modifications and variations are possible in light of the above teachings. Therefore, it is to be understood, that in the scope of the appended claims, the invention may be practiced other than as specifically described.

What is claimed is:

1. A structural panel comprising:
a solid base sheet;
at least one decorative member fastened to the solid base sheet;
a seal having a smooth outer surface and formed of at least one light passing material, wherein the at least one decorative member may be viewed through the at least one light passing material.

2. A structural panel in accordance with claim 1 wherein the solid base sheet is an impermeable sheet.

3. A structural panel in accordance with claim 1 wherein the seal includes at least one functional sized and shaped seal.

4. A structural panel in accordance with claim 2 wherein the impermeable sheet is a solid sheet having an uneven surface.

5. A structural panel in accordance with claim 1 in which the solid base sheet includes wax

6. A structural panel in accordance with claim 4 wherein the impermeable sheet is a polyurethane sheet.

7. A structural panel in accordance with claim 1 wherein the at least one decorative member is a mosaic consisting of multiple decorative separate pieces each of which is fastened to the solid base sheet.

8. A structural panel in accordance with claim 1 wherein the at least one decorative member is a painting.

9. A structural panel in accordance with claim 1 wherein the at least one decorative member is a layer of material with a surface having a decorative shape.

10. A structural panel in accordance with claim 1 wherein the seal is a clear transformable material.

11. A structural panel in accordance with claim 10 wherein the clear transformable material is a hardenable time transformable material.

12. A structural panel in accordance with claim 10 wherein the clear transformable material is a hardenable chemically transformable material.

13. A structural panel in accordance with claim 12 wherein the hardenable chemically transformable material is an epoxy material.

14. A method of making a structural panel, comprising the steps of:
incorporating a solid base sheet;
applying at least one decorative member to the solid base sheet; and
applying a functional sized and shaped seal.

15. The method of claim 14 wherein the step of incorporating a solid base sheet includes the step of incorporating an impermeable sheet.

16. The method of claim 14 wherein the step of incorporating a solid base sheet includes the step of incorporating a semi-permeable sheet.

17. The method of claim 14 wherein the step of incorporating a solid base sheet includes the steps of:
obtaining a permeable base sheet;
closing openings of the permeable base sheet with a removable material prior to applying the at least one decorative member; and
applying an adhesive material while the openings of the permeable base sheet are closed.

18. The method of claim 14 wherein the step of applying at least one decorative member includes the step of:
applying an adhesive to the solid base sheet; and
applying the at least one decorative member.

19. The method of claim 14 wherein the step of applying a functional sized and shaped seal comprises the steps of applying a self-leveling coat to the solid base sheet and said at least one decorative member, wherein the self-leveling coat forms a smooth protective layer.

20. The method of claim 19 wherein the step of applying a self-leveling coat comprises the step of applying a light passing epoxy wherein the at least one decorative member may be seen through the epoxy.

21. The method of claim 20 wherein the self-leveling coat is transparent.

22. The method of claim 20 wherein the self-leveling coat is colored.

23. A method of installing structural panels, comprising the steps of:
forming a plurality of structural panels each of which comprises a solid base sheet, at least one decorative member fastened to the solid base sheet and a seal having a smooth outer surface and formed of at least one light passing material, wherein the at least one decorative member may be viewed through the at least one light passing material; and
delivering the plurality of structural panels to a purchaser wherein the structural panels may be installed on a surface.

24. A method in accordance with claim 23 further including the steps of laying down mortar on a surface to receive the structural panels and pressing the solid base sheet against it.

25. A method in accordance with claim 23 further including the step of fastening the panels to a vertical surface with brackets.

26. A method in accordance with claim 23 further including the step of fastening the panels to a horizontal surface with brackets.
